(19) United States
(12) Patent Application Publication
(10) Pub. No.: US 2022/0276380 A1
(43) Pub. Date: Sep. 1, 2022

(54) METHOD, COMPUTER PROGRAM, ELECTRONIC MEMORY MEDIUM, AND DEVICE FOR EVALUATING OPTICAL RECEPTION SIGNALS

(71) Applicant: Robert Bosch GmbH, Stuttgart (DE)

(72) Inventors: Alexander Greiner, Reichenbach (DE); Reiner Schnitzer, Reutlingen (DE); Siegwart Bogatscher, Leonberg (DE)

(73) Assignee: Robert Bosch GmbH, Stuttgart (DE)

(21) Appl. No.: 17/638,034

(22) PCT Filed: Oct. 13, 2020
(86) PCT No.: PCT/EP2020/078706

§ 371 Date: Feb. 24, 2022

(30) Foreign Application Priority Data
Oct. 16, 2019 (DE) 10 2019 215 951.6

(51) Int. Cl. G01S 17/10; G01S 7/487

(52) U.S. Cl. CPC G01S 17/10; G01S 7/4873; G01S 7/4876

(57) ABSTRACT

A method for evaluating optical reception signals. The method includes: emitting multiple optical emission signals for reception as optical reception signals, the respective emission signals being emitted equidistantly varying; receiving optical reception signals; associating the respective received optical reception signals with the multiple optical emission signals; evaluating the received optical reception signals as a function of the respective maximum values of the associated optical reception signals.

LIDAR sensors will become established in the coming years in the implementation of highly-automated driving functions. Presently, conventional mechanical laser scanners cover only large horizontal detection angles between 150° and 360°. In a first embodiment of the present invention, the rotating mirror laser scanners, whose maximum detection range is restricted to approximately 120°, only a motor-driven deflection mirror rotates. For larger detection ranges up to 360°, all electro-optical components are located on a motor-driven turntable or rotor.

### BACKGROUND INFORMATION

LIDAR systems using multi-pulses are conventional. Systems which use such multi-pulses within one measurement are primarily described in the literature. One measurement is understood as the emission of a predetermined number of laser pulses. The number is 3 to 6, sometimes up to 20, in particular 12 pulses. This approach has multiple disadvantages.

If one uses multi-pulses within a measurement, it is to be ensured that the laser pulses are emitted at a very short interval, typically in the nanosecond range, in particular up to a few tens of nanoseconds. A significantly more complex charging circuit for the laser is required for this purpose, since the time between the pulses is not sufficient to recharge for the next shot. This problem may be bypassed using constant current sources, however, such sources have the problem that in the event of a malfunction, a very high laser power may be generated, due to which the eye safety becomes a problem. Very complex safety mechanisms would then be necessary here.

In addition, such systems have the problem that very poor statistics are provided for the measurement due to the typically low number of the pulses (typically 3 to 6, sometimes up to 20, in particular 12). The problem thus results that in cases of a very low signal, the ascertained distance may jump.

It is to be mentioned as the last disadvantage that in such a system the evaluation of the signals is very complex. Filters which cover the entire time range of the multi-pulses are required.

Very long filters are thus obtained, due to which the computing effort of such an evaluation is very high.

A further option for implementing such a multi-pulse system is the use of pulses at the interval of the measurement range. If one wishes to measure up to a distance of 300 m, for example, the time interval would thus be 2 μs. This time is sufficient to again charge a present charge circuit for the next laser. It is thus possible to use simple charge circuits and reliably maintain the requirements for the eye safety using simple means.

Furthermore, aggregating the received signals after the emission of a laser pulse in a histogram is conventional. After all laser pulses of one measurement have been emitted, the aggregated histogram may be evaluated easily. All received signals may be added up to form one signal, for example, and this may be analyzed with the aid of simple filters.

One fundamental problem of such a system is given by the restricted unambiguous range. This unambiguous range is determined by the time interval of the pulses.

The restricted unambiguous range results in the occurrence of ghost echoes. Ghost echoes represent undesirable detection artifacts.

Ghost echoes are understood as received signals which are located outside the unambiguous range of a system. This may occur, for example, in that in a LIDAR system, an emitted laser beam is reflected at an object which is farther away than the detection range of the system. When the reflected signal is received, this may have the result that the received signal cannot be associated with the correct emitted signal. The signal transit time may thus be calculated incorrectly and thus the distance to the object may be ascertained incorrectly.

Furthermore, signals of external sensors represent undesirable detection artifacts.

### SUMMARY

An object of the present invention is to contribute to eliminating detection artifacts, such as the mentioned ghost echoes or signals of external sensors.

For this purpose, the present invention provides a method for evaluating optical reception signals. In accordance with an example embodiment of the present invention, the method includes the following steps.

Emitting multiple optical emission signals to be received as optical reception signals. The method of the present invention is distinguished in that, among other things, the respective emission signals are emitted equidistantly varying.

Receiving optical reception signals.

Associating the respective received optical reception signals with the multiple optical emission signals.

Equidistantly varying emission of optical emission signals is understood in the present case to mean that the individual pulses (optical emission signals) are emitted at a time interval in relation to one another which is dependent on the predetermined unambiguous range of the system, and therefore equidistantly. To be able to more easily identify ghost echoes and signals of external sensors, the equidistant interval is varied in such a way that, on the one hand, the size of the unambiguous range is not significantly influenced and, on the other hand, ghost echoes are easier to identify. This means that the resulting variation is minor in comparison to the time interval. If the time interval is 2 μs at a given unambiguous range of 300 m, for example, the variation may thus be in the range of up to 100 ns, in particular in the range between 10 ns and 40 ns.

An optical emission signal may be understood in the present case as a laser pulse of a multi-pulse LIDAR system.

An optical reception signal may be understood in the present case as a signal which was detected by a detector of a LIDAR system due to the reflection of an optical emission signal.

Moreover, an optical emission signal is also understood as a signal of an external sensor which was randomly detected by a detector of a LIDAR system. Furthermore, an optical reception signal may be understood as a signal which results in background noise in the detector of a LIDAR system. This includes, among other things, background illumination and thermal noise. In principle, this is understood to include any signal which was detected by a detector of a LIDAR system.

In accordance with an example embodiment of the present invention, the method is distinguished by the step of evaluation, according to which the received optical reception signals are evaluated as a function of the respective maximum values of the associated optical emission signals.

Evaluation may be understood in the present case, on the one hand, as extracting pieces of information from the reception signals and, on the other hand, processing the reception signals in such a way that such an information extraction may take place more easily or reliably. This includes, for example, the removal of undesirable detection artifacts. Pieces of information to be extracted are, among other things, the presence of an object in general and the distance of this object in particular.

According to one specific embodiment of the present invention, in the step of evaluation, the evaluation is carried out as a function of a threshold value for the respective maximum values.

According to this specific embodiment of the present invention, during the evaluation of the optical reception signals, the reception signals may be evaluated as a function of the maximum values which exceed the threshold value. This has the result that in cases in which the respective maximum values are excluded from the evaluation, only those are still excluded which originate from undesirable detection artifacts with a probability bordering on certainty. Overall, fewer or only interfering information components are thus excluded from the evaluation. This results in more accurate evaluation results.

According to one specific embodiment of the method of the present invention, the method includes the additional step of pre-filtering after the step of receiving the optical reception signals.

A further aspect of the present invention is a computer program which is configured to carry out all steps of one of the specific embodiments of the method of the present invention.

A further aspect of the present invention is an electronic memory medium on which a computer program according to one aspect of the present invention is stored.

A further aspect of the present invention is a device which is configured to carry out all steps of one of the specific embodiments of the method of the present invention. Such a device may be designed in the form of a so-called application-specific integrated circuit (ASIC).

Specific example embodiments of the present invention are explained in greater detail hereinafter on the basis of the figures.

### BRIEF DESCRIPTION OF THE DRAWINGS

FIG. 1 shows an exemplary time sequence of a measurement.

FIG. 2 shows an exemplary time sequence of a measurement in the detector.

FIG. 3 shows a histogram of the evaluation of the optical reception signals.

FIG. 4 shows a block diagram of one specific embodiment of the present invention.

FIG. 5 shows a block diagram of another specific embodiment of the present invention.

FIG. 6 shows a block diagram of another specific embodiment of the present invention.

FIG. 7 shows a block diagram of another specific embodiment of the present invention.

FIG. 8 shows a block diagram of another specific embodiment of the present invention.

FIG. 9 shows a flowchart of one specific embodiment of the method of the present invention.

### DETAILED DESCRIPTION OF EXAMPLE EMBODIMENTS

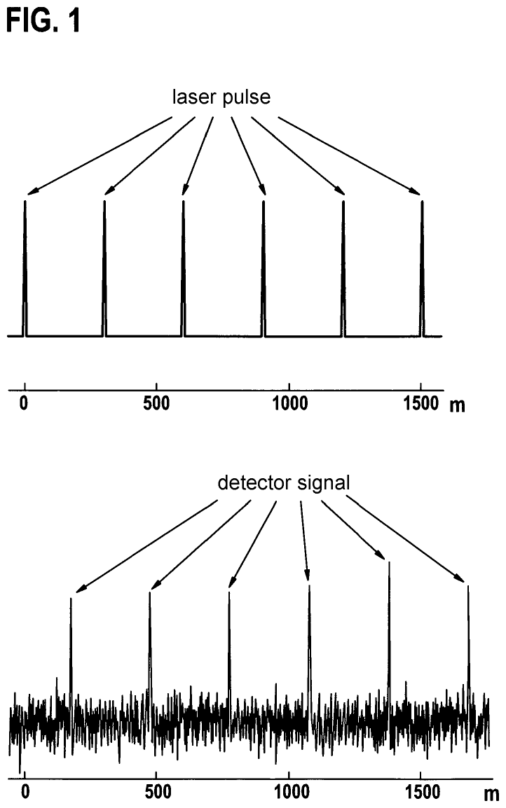

FIG. 1 shows an example of the time sequence of a measurement.

In the top diagram, the 6 laser pulses of a measurement are plotted over a time axis, which indicates the distance in meters as a function of the transit time of the laser beam.

It is apparent from the points in time of the laser pulses that the unambiguous range is 300 m. This is apparent from the fact that the laser pulses are emitted at a time interval in relation to one another which corresponds to the transit time of a laser beam of 300 m.

In the bottom diagram, the measurement in the detector in the same time period is plotted by way of example. It is apparent from the deflection, which occurs the first time after a time corresponding to a transit time of 180 m, and then regularly in each case after a time which corresponds to a transit time of 300 m and accordingly precisely after the time after which a further laser pulse was emitted in each case, that an object was recognized that is located at a distance of approximately 180 m.

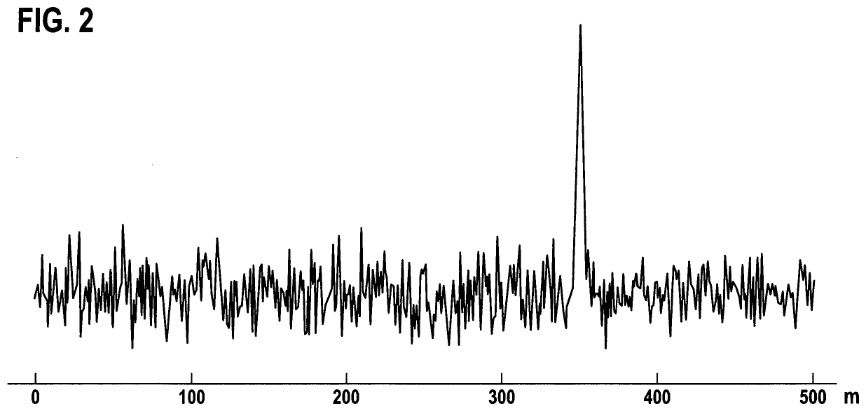

FIG. 2 shows an example of a measurement in the detector which results when an object was recognized which is located outside the unambiguous range.

In the measurement shown, an object was recognized which is located at a distance of approximately 350 m. With an unambiguous range of only 300 m, without appropriate countermeasures, a distance of only 50 m would be ascertained for this object due to, for example, the detection of ghost echoes.

Such an incorrect measurement may result in significant problems.

The present invention provides appropriate countermeasures for this purpose.

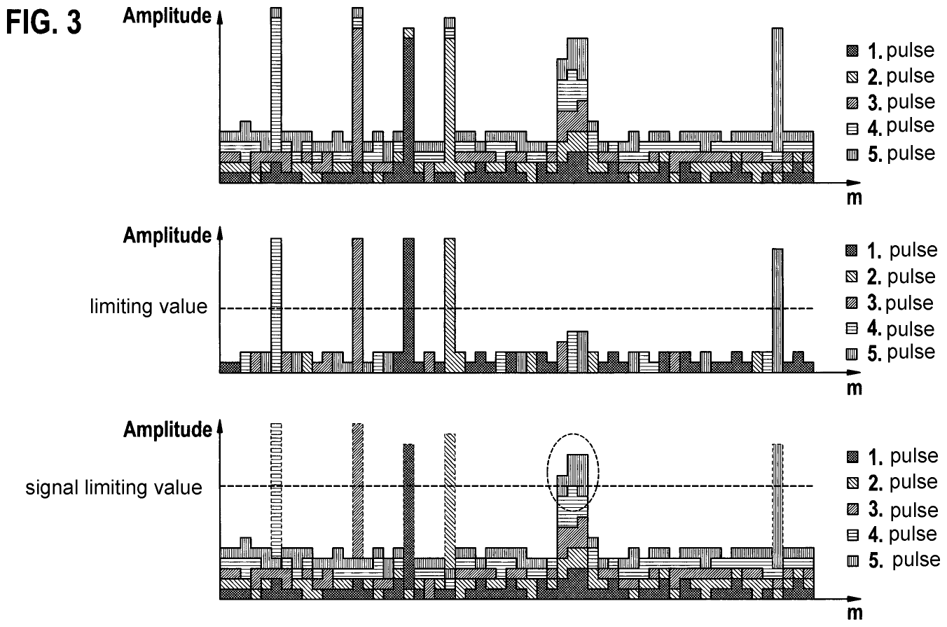

FIG. 3 shows exemplary measurement data which result upon use of the present invention.

The first histogram shows an aggregation of the amplitudes of the detected signals over a time range which corresponds to the unambiguous range. The aggregation essentially corresponds to the addition of the detected signals (including the noise component).

The second histogram shows the amplitude of the highest shot (maximum hold histogram) per time unit which corresponds to a particular distance on the basis of the transit time of the laser beam.

The first histogram may now be evaluated as a function of the second histogram. An evaluation may, for example, include subtracting the values of the second histogram from the values of the first histogram. All signals which only originate from a single shot are thus eliminated. It is thus possible to reliably eliminate ghost echoes or signals of external sensors. Incorrect evaluations due to these detection artifacts are thus avoided.

The third histogram in FIG. 3 shows the result of one specific embodiment of the present invention, according to which in the step of the evaluation, the evaluation takes place as a function of a threshold value for the maximum values in each case.

This means in detail that only those signals of the maximum hold histogram which exceed the predetermined threshold value are taken into consideration in the evaluation of the reception signals. These are the individual strong deflections in the second histogram.

As is apparent from the third histogram, detection artifacts such as ghost echoes and signals of external sensors may thus be eliminated very reliably without further information, for example, the low-threshold background noise, being eliminated at the same time. The evaluation of the reception signals is thus possible more accurately and with greater detail.

In particular, this specific embodiment effectively prevents “real signal components” from being subtracted and thus the range of the system from being impaired.

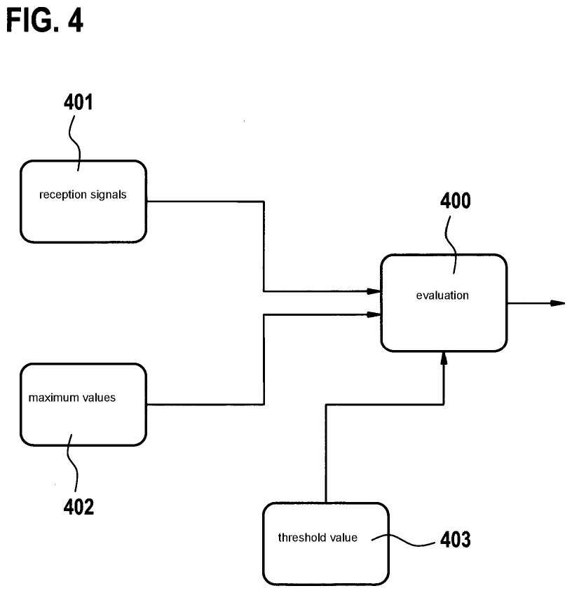

FIG. 4 shows a block diagram of one specific embodiment of the present invention

The specific embodiment is based on reception signals 401 and the respective maximum values 402 of the associated optical reception signals being provided for evaluation. Furthermore, a threshold value 403 for the respective maximum values 402 is provided for the evaluation.

Reception signals 401 and maximum values 402 are provided in the form of histograms. In the histograms, reception signals 401 and the maximum values associated with the reception signals are plotted over the unambiguous range. Reception signals 401 are each associated with one emission signal. The duration begins again after each emission of an emission signal. Accordingly, the reception signals may be plotted one over another (see FIG. 3, first histogram). For each unit of time, furthermore the maximum value of the respective unit of time is plotted according to the associated emission signal (see FIG. 3, second histogram).

The reception signals are then evaluated as a function of the respective maximum values of the associated optical reception signals and as a function of a threshold value for the respective maximum values of maximum hold histogram 402 in block 400.

This means that the respective maximum value 402 of the respective unit of time is subtracted from the reception signals. Detection artifacts may thus be eliminated effectively and efficiently. In order to eliminate as little information as possible according to this specific embodiment, the respective maximum value 402 is only subtracted when corresponding maximum value 402 of the unit of time exceeds provided threshold value 403 for the respective maximum values. The eliminated information may thus be reduced to the aspects which are to be attributed with high probability to detection artifacts.

As a result of the evaluation, a distance of the detected object may be ascertained.

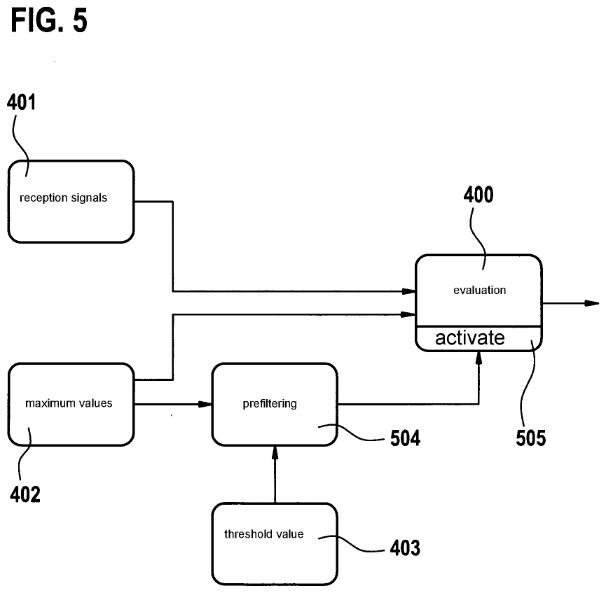

FIG. 5 shows a further block diagram of another specific embodiment of the present invention.

The evaluation of reception signals 401 also takes place as a function of the respective maximum values 402 of associated optical reception signals 401 and as a function of a threshold value 403 for of the respective maximum values 402 in this specific embodiment.

In addition, according to the specific embodiment shown, maximum values 402 are prefiltered for smoothing. This filtering may be applied, for example, to a histogram of the maximum values (cf. FIG. 3, second histogram). Conventional methods come into consideration as the filter method, among others, matched filter or top head filter.

According to this specific embodiment, the respective maximum value 402 is subtracted from reception signal 401 when the corresponding filtered maximum value exceeds threshold value 403.

The advantage of this specific embodiment is that due to this type of prefiltering, undesirable effects may be reduced or avoided upon filtering following the evaluation.

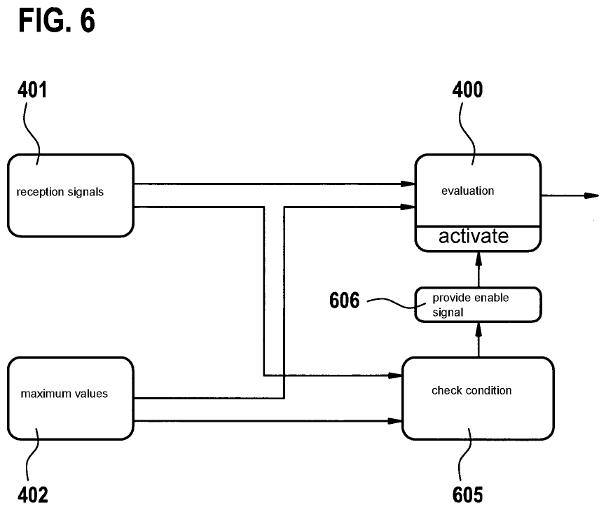

FIG. 6 shows a block diagram of another specific embodiment of the present invention.

According to this specific embodiment, evaluation 400 of reception signal 401 takes place as a function of a respective maximum value 402 for the reception signal. It is checked in block 605 whether reception signal 401 is less than the respective maximum value 402.

The respective maximum value 402 may be adapted with the aid of a predetermined factor. This factor may in general be an application factor which is determined during the configuration of a corresponding system in consideration of the relevant condition. Typically using corresponding heuristics.

If the condition checked in block 605 applies, in block 400, reception signal 401 is evaluated as a function of maximum value 402. One aspect of this evaluation may be the subtraction of maximum value 402 from reception signal 401. Furthermore, this consideration takes place for a predetermined number of units of time. This is represented by block 606, which provides an enable signal to block 400 for a predetermined number of units of time if the condition of block 605 applies.

This specific embodiment provides in a simple manner an evaluation of reception signals 401 with the aid of elimination of interfering detection artifacts, such as ghost echoes and signals of external sensors.

The simple implementation has the result that, among other things, signal components are eliminated from reception signals 401 which have contained pieces of information. However, this has no significant influence on the overall performance i.e., the capability of determining the distance of detected objects.

Such a specific embodiment is particularly suitable for implementation in resource-poor environments, for example, for embedded applications.

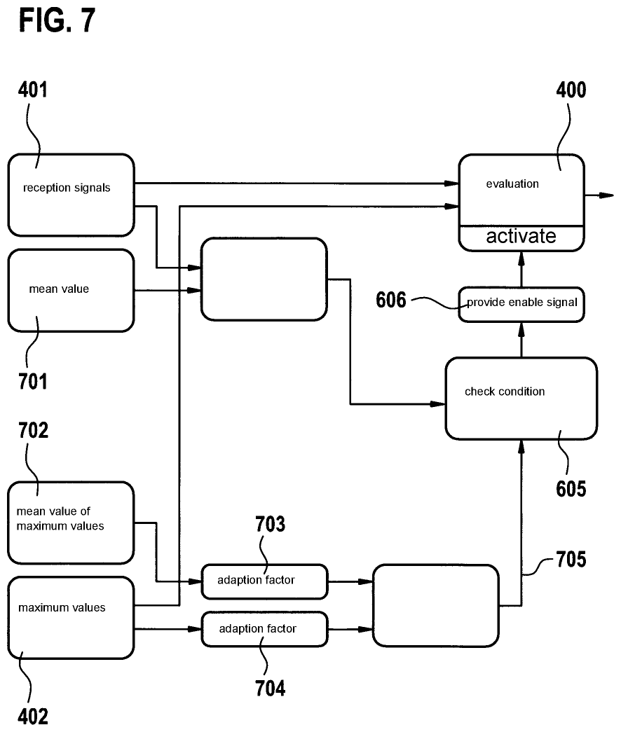

FIG. 7 shows a block diagram of another specific embodiment of the present invention.

Evaluation 400 of reception signals 401 additionally takes place according to this specific embodiment as a function of the mean value of background noise 701 and the mean value of maximum values 702.

This dependency of the evaluation is reflected according to this specific embodiment in the part of the evaluation which results in the decision as to whether the respective maximum values 402 are to be subtracted from reception signal 401 upon evaluation 400.

For this decision, mean value 701 of reception signal 401 is ascertained. This value essentially characterizes the influence of the background noise on reception signal 401.

Furthermore, mean value 702 of the respective maximum values 402 is ascertained.

The reception signal adjusted by the influence of the background noise in block 605 is used as the underlying basis for decision 605 whether the respective maximum value 402 is to be subtracted from reception signal 401 upon evaluation 400.

In this block, the comparison to value 705 adjusted by mean value 702 of maximum value 402 takes place.

To adjust maximum value 402, according to this specific embodiment, both maximum value 402 and mean value 702 are each adapted with the aid of a factor 703, 704.

The specific embodiment is based on the finding that maximum value 402 is only subtracted at the corresponding point from reception signal 401 if reception signal 401 at the corresponding point only originates from one laser pulse. In other words, if the signal level in the histogram of reception signal 401 (cf. FIG. 3, first histogram) includes additional signal from other laser pulses at the point in question. Maximum value 402 of the corresponding point is only subtracted if this is not the case.

This approach has the result that upon the reception of strong signals, i.e., of reception signals 401 having a high amplitude, the first received signal is subtracted because it is incorrectly handled like a ghost echo or as a signal of an external sensor, i.e., as a detection artifact.

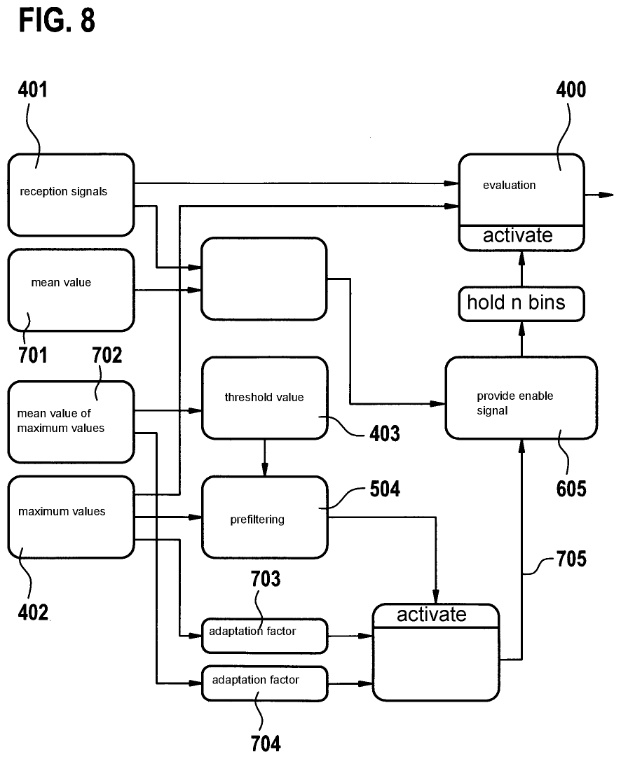

FIG. 8 shows a block diagram of another specific embodiment of the present invention.

It proceeds from the specific embodiment according to FIG. 7. In addition, for decision 605 as to whether maximum value 402 is to be subtracted from reception signal 401, the consideration of a threshold value 403 and prefiltering 504 of maximum value 402 take place according to the specific embodiment according to FIG. 5.

According to this specific embodiment, signal peaks may be eliminated in the background noise. The elimination of these signal peaks would not be necessary. At the same time, they have no significant effect on the performance of this specific embodiment, i.e., on the determination of the distance of the detected objects.

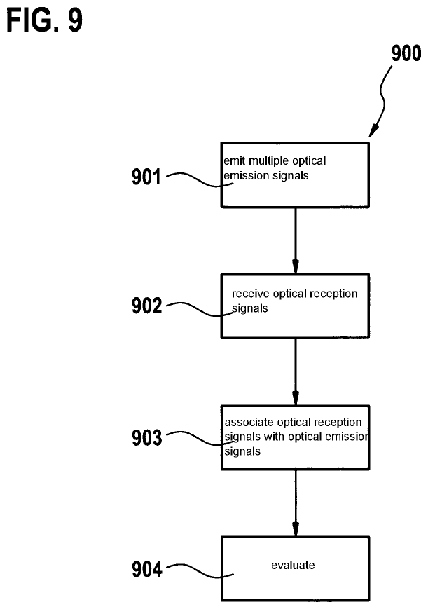

FIG. 9 shows a flowchart of one specific embodiment of the method of the present invention.

In step 901, multiple optical emission signals are emitted for reception as optical reception signals 401. The step of emission 901 distinguishes the present invention in that the optical emission signals are emitted equidistantly varying.

In step 902, optical reception signals 401 are received. Optical reception signals 401 may have been received in reaction to the emission of the optical emission signals. This is the case, for example, if the optical emission signal has struck an object and was reflected thereby. The optical reception signal is then a reflection of a previously emitted optical emission signal. Furthermore, the optical reception signals may be so-called optical background noise. This typically exists and originates from reflection of natural or artificial electromagnetic sources, for example, natural or artificial light sources. Furthermore, the optical background noise may originate from the thermal noise of the components used in or at the detector.

In step 903, the optical reception signals are associated with the optical emission signals. The transit time of an optical emission signal may be determined on the basis of this association and the distance of the detected object may be ascertained via the transit time.

One approach of the association may be that all reception signals which are received after the emission of one emission signal and before the emission of the further emission signal are associated with the emission signal.

In step 904, the received optical reception signals are evaluated as a function of the respective maximum values of the associated reception signals.

Such an evaluation may be carried out, for example, via the evaluation of histograms. The reception signals are added together in a first histogram over the duration of the unambiguous range. In a second histogram, the respective maximum values are held over the same duration (maximum hold histogram).

Undesirable detection artifacts, such as ghost echoes and signals from external sensors, may be eliminated with the aid of the present invention by evaluation 904 of the reception signals as a function of the respective maximum values.

Such an elimination may be carried out, for example, in that the maximum values at the respective points are subtracted from the reception values.

Further specific embodiments of the present invention may partially supply more accurate signal evaluations in a simpler manner within the scope of the step of evaluation 904 of the reception signals.

1-7. (canceled)

8. A method for evaluating optical reception signals, comprising the following steps:
emitting multiple optical emission signals for reception as optical reception signals, the emission signals being emitted equidistantly varying;
receiving optical reception signals;
associating the received optical reception signals with the multiple optical emission signals; and
evaluating the received optical reception signals as a function of respective maximum values of the associated optical reception signals.

9. The method as recited in claim 8, wherein in the step of evaluating, the evaluation is carried out as a function of a threshold value for the respective maximum values.

10. The method as recited in claim 9, further comprising:
prefiltering the respective maximum values, wherein the evaluation as a function of the respective maximum values is carried out as a function of the application of the threshold value to the prefiltered maximum values.

11. The method as recited in claim 8, wherein in the step of evaluating, the evaluation is carried out as a function of a factor for each of the respective maximum values.

12. A non-transitory electronic memory medium on which is stored a computer program for evaluating optical reception signals, the computer program, when executed by a computer, causing the computer to perform the following steps:
emitting multiple optical emission signals for reception as optical reception signals, the emission signals being emitted equidistantly varying;
receiving optical reception signals;
associating the received optical reception signals with the multiple optical emission signals; and
evaluating the received optical reception signals as a function of respective maximum values of the associated optical reception signals.

13. A device, comprising:
an application-specific integrated circuit configured to evaluate optical reception signals, the application-specific integrated circuit configured to:
emit multiple optical emission signals for reception as optical reception signals, the emission signals being emitted equidistantly varying;
receive optical reception signals;
associate the received optical reception signals with the multiple optical emission signals; and
evaluate the received optical reception signals as a function of respective maximum values of the associated optical reception signals.
